(19) United States
(12) Patent Application Publication
(10) Pub. No.: US 2012/0140082 A1
(43) Pub. Date: Jun. 7, 2012

(54) SYSTEM AND METHOD OF SUBMERGED ORGANISM DETECTION BY ROTATIONAL LASER LIGHT

(75) Inventors: Tihomir Makovec, Koper (SI); Edvin Salvi, Izola (SI)

(73) Assignee: National Institute of Biology

(21) Appl. No.: 12/961,956

(22) Filed: Dec. 7, 2010

(51) Int. Cl. H04N 5/225; G03B 17/08; G03B 15/03

(52) U.S. Cl. 348/207.1; 396/155; 396/28; 348/E05.024

(57) ABSTRACT

A submerged organism detection system. Particularly, a system and method for detection of organisms and includes a rotational mirror and laser light. The system has a camera with a visible field and detects a flash; a laser device produces a laser beam; a mirror rotates about an axis and reflects the laser beam throughout a plane, the plane being substantially horizontal, the visible field being a portion of the plane, wherein, when an object obstructs the laser beam, the flash is produced; and a counter that has a count, wherein, when the flash is produced, the counter increases the count. Further, the system may be submerged underwater.

### BACKGROUND

1. Field of the Invention

The present disclosure relates to a submerged organism detection system. Particularly, the present disclosure relates to a system and method for detection and counting of organisms comprising a microprocessor, a rotational mirror, a flash detecting camera, and laser light.

2. Description of the Related Art

Detection and counting of organisms underwater is of particular interest to the scientific community. Oceanic research relating to species count, species depletion, migration habits, and concentrations in a given area are of particular importance.

Conventional technologies that assist in detection and counting of underwater organisms may be invasive. Systems that utilize SONAR, for example, have been shown to cause damage in many underwater organisms due to the frequency and magnitude of noise. Other techniques, such as planktonic netting, rely upon physical capture of organism and typically harm or kill such organisms.

Recent years, however, have seen a shift in detection methods due to advances in technology. Such advances, however, tend to overcomplicate detection methods and require sensitive and expensive equipment. The detection and imaging technique described in U.S. Pat. No. 6,304,289 (hereinafter “the '289 patent”) exemplifies an overly complicated system with a limited area of detection. The '289 patent provides for a sophisticated imaging technique requiring precision control of laser oscillators and sensitive image pickup equipment. Similarly, U.S. Pat. No. 6,737,971 (hereinafter “the '971 patent”) overcomplicates laser detection techniques and requires backscatter information. Further, neither the '289 patent nor the '971 patent provide an ability to count organisms.

Conventional detection techniques suffer drawbacks due to the level of invasiveness and potential damage to aquatic life. More recent detection techniques suffer drawbacks associated with overly complicated designs and the rising cost associated with sophisticated equipment.

Due to these deficiencies, a need remains for a simplified low cost noninvasive system and method to detect and count submerged organisms.

### SUMMARY

A system is disclosed having a camera with a visible field and detects a flash; a laser device produces a laser beam; a mirror rotates about an axis and reflects the laser beam throughout a plane; the plane being substantially horizontal; the visible field being a portion of the plane; when an object obstructs the laser beam, the flash is produced; and a counter that has a count, wherein, when the flash is produced, the counter increases the count. Further, the system may be submerged underwater.

A second system is disclosed having a camera, a laser device, a mirror, and a microprocessor in communication with a database. The laser device produces a laser beam; the mirror rotates about an axis and reflects the laser beam in a plane, the plane being substantially horizontal and the camera records an image of a portion of the plane; and the microprocessor in communication with the camera and a database, stores the image in the database.

A method is also disclosed. The method includes producing a light about a plane using a laser beam and a rotational mirror; the plane being substantially horizontal; detecting a flash within a portion of the plane with a camera; when an object obstructs the laser beam the flash is produced; counting objects with a counter having a count that increases when the flash is produced and storing the count in a database.

The above-described and other features and advantages of the present disclosure will be appreciated and understood by those skilled in the art from the following detailed description, drawings, and appended claims.

### BRIEF DESCRIPTION OF THE DRAWINGS

FIG. 1 is a schematic of one embodiment of a system of submerged organism detection by rotational laser light.

FIG. 2 is a schematic highlighting system components of FIG. 1.

FIG. 3 is a schematic of a laser device 300 and a rotating mirror device 301.

FIG. 4 is a schematic of system 400 for detection of submerged organisms detection by rotational laser light.

FIG. 5 is a method of submerged organism detection by rotational laser light.

FIG. 6 is a block diagram of system 600, according to the present disclosure.

### DESCRIPTION OF THE PREFERRED EMBODIMENT

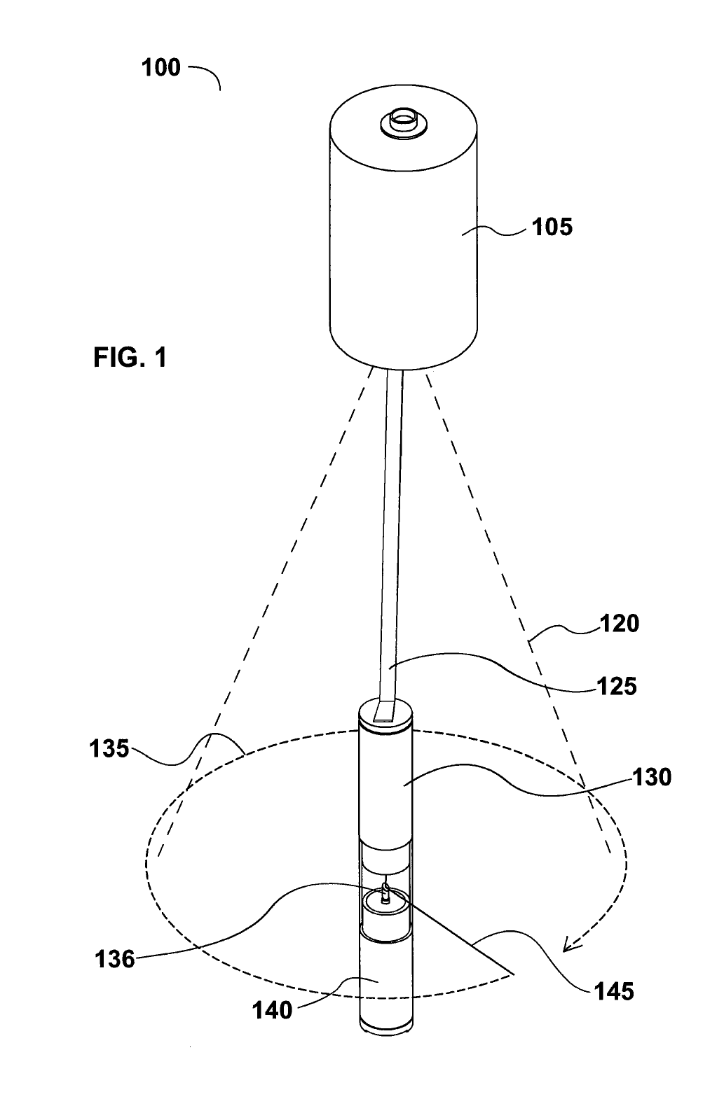

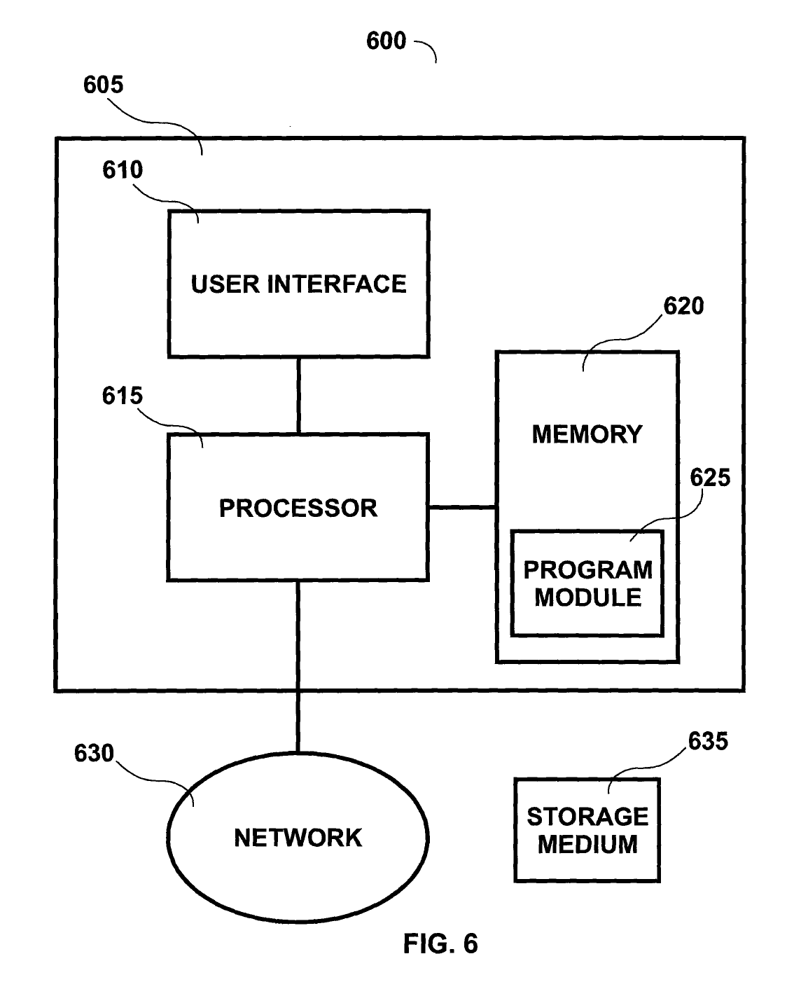

FIG. 1 is a schematic of one embodiment of a system of submerged organism detection by rotational laser light 100. System 100 includes camera 105, placement device 125, laser device 130, and mirror 136. Laser device 130 produces a laser beam 145 which is reflected off mirror 136. Mirror 136 rotates about an axis and reflects the laser beam 145 throughout a plane 135. Plane 135, in an exemplary embodiment is substantially horizontal. Visible field 120 can encompass and overlap a portion of plane 135. Rotation of mirror 136 is done by drive device 140. Drive device 140 can be a motor, e.g., an electromotor, and rotates mirror 136. Placement device 125, as illustrated, can be a rod. Placement device 125 may position the laser device 130 and mirror 126 within the camera's visible field 120. As illustrated, laser device 130 is fixed to a bottom portion of camera 105 by placement device 125. Camera 105 can be positioned perpendicularly relative to laser beam 145 to maximize overlap of visible field 120 and plane 135. In system 100, camera 105 can be capable of detecting a flash. A flash occurs when an object is illuminated by laser beam 145. An object may become illuminated by laser beam 145 when the object obstructs laser beam 145. Camera 105 may also incorporate a counter to tally the quantity of objects that produced a flash. The counter can have a count that is increased when a flash occurs. The counter may also be independent of camera 105, or alternatively, the counter may be incorporated into camera 105. Camera 105 may also record an image when a flash is detected. This recorded image may further be stored in a database. Additionally, in other embodiments, camera 105 may record video which may also be stored in a database. The database may be contained within camera 105, e.g. onboard memory, or the database may be a separate and distinct device capable of communicating with and storing images from camera 105 (Ref. FIG. 6).

System 100, in some embodiments, may be submerged underwater, but it is also be to understood that system 100 may be submerged in multiple environments and multiple fluids, gasses, and combinations thereof. In exemplary embodiments, system 100 may be used to count aquatic organisms such as jellyfish and ctenophores. Typically, such system is deployed in low light or no light environments. In operation, system 100 is lowered into water and continues to sink toward the bottom. During the course of sinking, laser beam 145 illuminates about plane 135 while camera 105 records flashes caused by objects obstructing the laser within visible field 120.

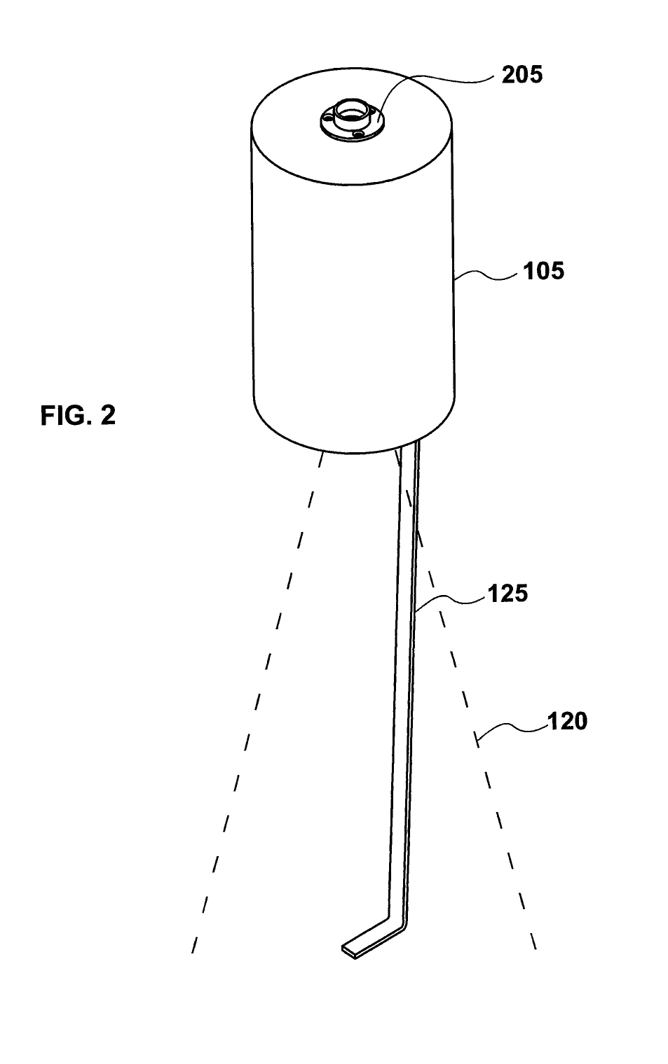

FIG. 2 highlights system components of FIG. 1. In particular, FIG. 2 illustrates camera 105, placement device 125, and visible field 120. Fixation device 125, as illustrated, is a rod and attached to a bottom portion of camera 105. FIG. 2 also illustrates connector 205. Connector 205 allows camera 105 to connect to a camera cable discussed in subsequent figures. The cable, in turn, may be connected to a power supply, a database, or an access device. Most underwater cameras are suitable for camera 105. Although placement device 125 is a rod, it should be noted that other forms of placement are also suitable. For example, in other embodiments, fixation device 125 may a wire or set of wires. Additionally, placement device 125 positions a laser device and a rotating mirror device in part of visible field 120. This may result in an obstruction of visible field 120, however, it is appreciated that use of smaller laser devices and smaller rotating mirror devices minimize this obstruction.

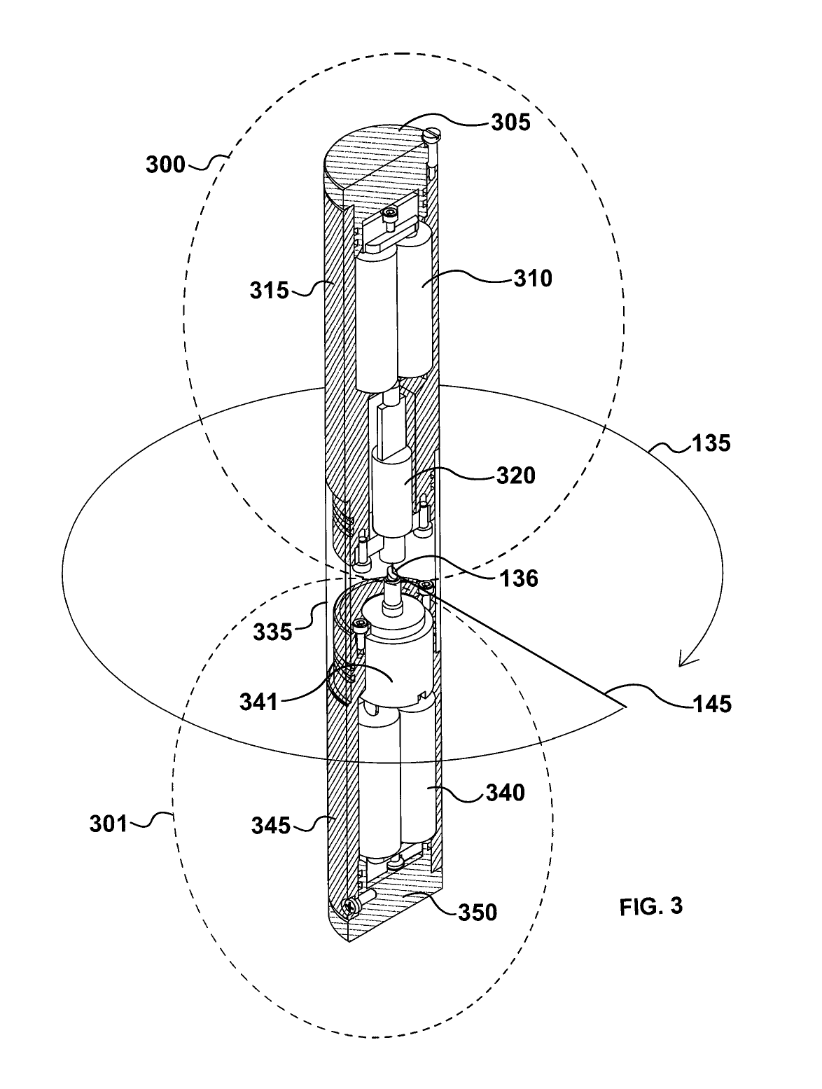

FIG. 3 is a schematic of a laser device 300 and a rotating mirror device 301. Laser device 300 is the same as laser device 130 in FIG. 1. Laser device 300 has a power supply unit 310. Power supply unit 310 powers laser generator 320 thereby producing laser beam 145. Laser beam 145 is the same as FIG. 1 laser beam 145. Laser device 300 also has waterproof housing 315 and also a waterproof housing 335 shared with rotating mirror device 301. Waterproof housing 335 is a transparent material, e.g. poly(methyl methacrylate), that allows laser beam 145 to pass without obstruction. Laser device 300 also has switch 305 capable of turning laser generator 320 on or off. Switch 305 may be a mechanical, electronic or combination electro-mechanical switch that disrupts power thereby rendering laser generator on/off. Rotating mirror device 301 also has waterproof housing 345 and (the above mentioned) shared waterproof housing 335. Rotating mirror device 301 additionally has a mirror 136. Mirror 136 is the same as FIG. 1 mirror 136. Mirror 136 rotates about an axis to reflect laser beam 145 along plane 135. Plane 135 is the same FIG. 1 plane 135. Plane 135, in exemplary embodiments can be substantially horizontal. Mirror 136 rotates about an axis by drive device 341. Drive device 341 may be a motor, e.g. an electromotor. Drive device 341 is powered by power supply unit 340. Both power supply unit 310 and power supply unit 340 are autonomous. Autonomous is defined as capable of providing power independently for a period of time without need for recharge or replacement. As illustrated, laser beam 145 is reflected 90 degrees from the point of generation by mirror 136 about plane 135. Laser beam 145 travels through the shared transparent housing 335 and illuminates the surrounding area. In typical embodiments, mirror 136 rotates about an axis with a high angular speed thereby providing illumination along plane 135. Further, in such embodiments, laser beam 145 may be directed to the exact middle of the mirror to provide proper reflection angles. Switch 350 controls drive device 341 and power supply 340. Switch 350 has an on and off position and may be a mechanical, electronic or combination electro-mechanical switch. Switch 350 disrupts power between drive device 341 and power supply 340 thereby starting or stopping mirror rotation. In the on position, mirror 136 will rotate according to the frequency of the drive device. In preferred embodiments two power supplies units are used to separately power laser generator 320 and drive device 341. In this fashion, no connection is necessary between power supplies, thereby allowing mirror 136 to reflect laser beam 145 throughout plane 135 without interruption of wires or connectors. In other embodiments, a plurality of rotating mirror devices and laser devices may be used to illuminate more than one plane. Such plurality of devices should be positioned to maximize illumination within a visible field of a camera. In some embodiments the plurality of devices could be stacked vertically. Additionally, the using a more powerful laser generator 320 will increase the level of illumination thereby providing a better visible field for a camera.

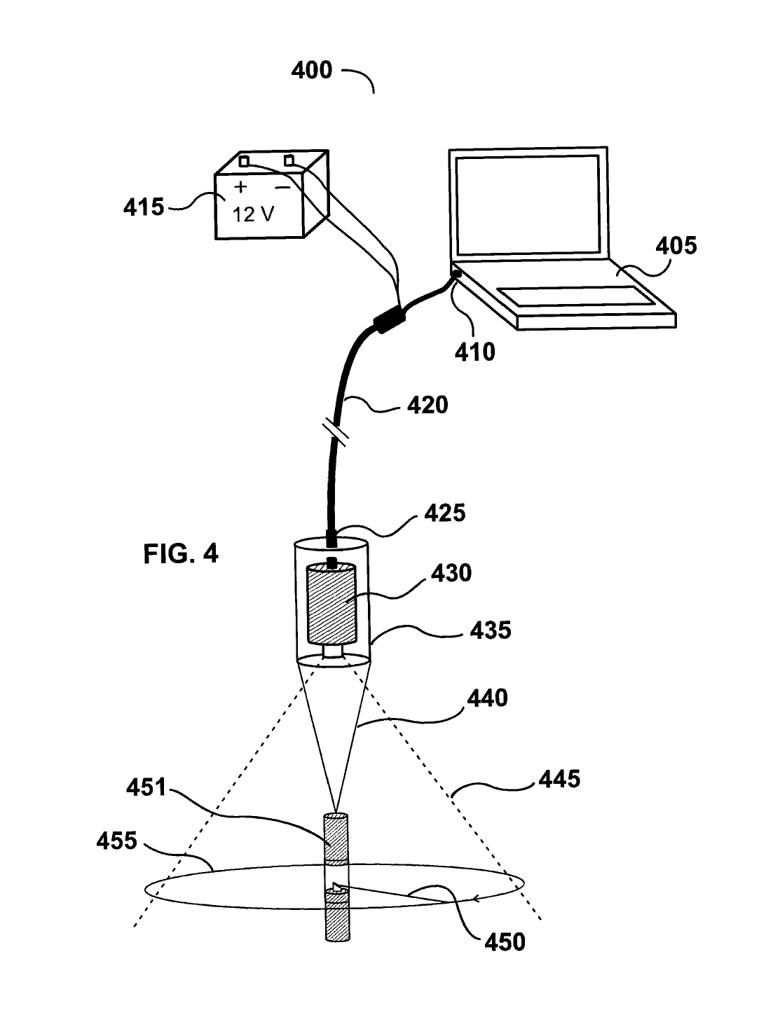

FIG. 4 is a schematic of system 400 for detection of submerged organisms detection by rotational laser light. System 400 includes access device 405, video connector 410, power supply 415, cable 420, camera connector 425, housing 435, camera 430, placement device 440, visible field 445, laser device 451, laser beam 450, and plane 455. Access device 405 may incorporate a display and also may incorporate a database. As illustrated, access device 405, may be a computer. It is also appreciated that modern computers may be in the form of phones, tablets, PDAs, or other electronic devices. Further, the database may be separate from access device 405. For example, the database may exist as a separate device, or alternatively, it may be contained within the camera 430, e.g. onboard memory. Laser beam 450 is reflected throughout plane 455 by a rotating mirror. Camera 430, enclosed in housing 435 has visible field 445. Housing 435 may be waterproof to allow submersion underwater. Visible field 445 can overlap a portion of plane 455. Laser beam 450 can be reflected about plane 455 and can extend beyond visible field 455. Placement device 440 includes wires to properly position laser device 451. Proper placement of laser device 451 is within the visible field 445 such that laser beam 450 is reflected about plane 455 in a substantially horizontal fashion. Such positioning, in an exemplary embodiment will maximize the overlap between visible field 445 and plane 450. Laser device 451, as illustrated, can be fixed to a bottom portion of camera 430 by placement device 440.

In operation, organisms travel through plane 450 within visible field 445 and are illuminated by laser beam 450, thereby producing a flash. The flash is recorded by camera 430 and when a flash is produced, an image is taken by camera 430. The image is preferably stored in a database. The database, in communication with access device 405, displays the image. Camera 430 is connected to camera connector 425. Camera connector 425 connects to power supply 415, thereby providing power to camera 430. In other embodiments, a separate and autonomous power supply can be enclosed within housing 435 to provide power to camera 430. Camera connector 425 may further connect to a database. The database in FIG. 4 is contained within access device 405. Camera 430 may optionally store images in the database. Access device 405, in communication with the database, may display such images.

In other embodiments, a counter may be incorporated into system 400 to tally the total quantity of organisms that disrupted laser beam 450. The counter can have a count that increases when a flash is produced. The counter may be a part of the camera 430, or alternatively, the counter may exist as an independent device.

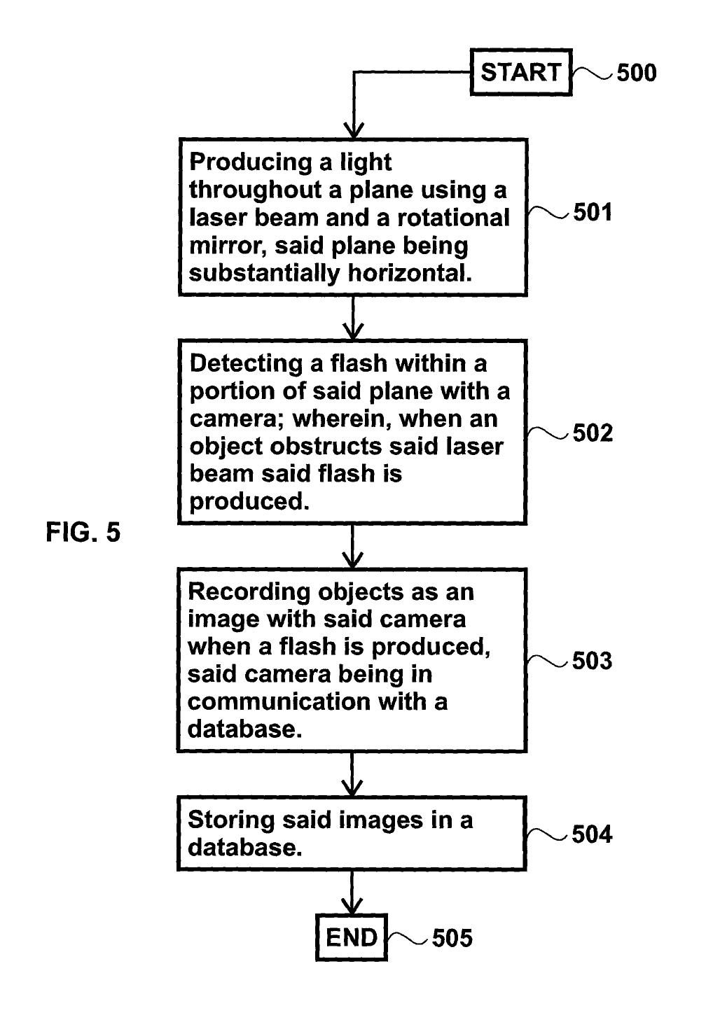

FIG. 5 illustrates a method of submerged organism detection by rotational laser light. Start step 500 indicates entry point into the method. Accordingly, the method next prescribes step 501: producing a light throughout a plane using a laser beam and a rotational mirror. The plane can be substantially horizontal. Next, step 502 provides for detecting a flash within a portion of the plane with a camera is required. If an object obstructs the laser beam, the object will become illuminated by laser light. A flash occurs when the object obstructs the laser beam, thereby becoming illuminated. Following this, step 503 provides for recording objects as an image with a camera. The camera may record objects as an image when the flash is produced. In an exemplary embodiment, waiting for a flash is desired since the method is typically deployed underwater in low or no light settings. Without such flash, images rendered would remain unclear. Following recordation step 503, step 504 provides for storage of the images in a database. The camera, in communication with a database, allows for such storage. The database may be onboard memory of the camera and contained within the camera unit. Referencing FIG. 4, a cable may be used to connect the camera to a database some distance apart. Finally, step 505 indicates END of the method.

FIG. 6 is a block diagram of a system 600. System 600 includes a computer 605 coupled to a network 630. System 600 may be part of a camera, or alternatively, system 600 may be an independent system shown in FIG. 4 described as an access device 405 (ref. FIG. 4).

Computer 605 includes a user interface 610, a processor 615, and a memory 620. Memory 620 may also be called a database for storing images recorded by a camera.

Although computer 605 is represented herein as a standalone device, it is not limited to such, but instead can be coupled to other devices, e.g. a camera, a rotational mirror, a laser device, a counter, or combinations thereof, in a distributed processing system.

User interface 610 includes an input device, e.g. a keyboard, for enabling a user to communicate information and command selections to processor 615. User interface 610 also includes an output device such as a display or a printer. A cursor control such as a mouse, track-ball, or joy stick, allows the user to manipulate a cursor on the display for communicating additional information and command selections to processor 615.

Processor 615 is an electronic device configured of logic circuitry that responds to and executes instructions.

Memory or database 620 is a computer-readable medium encoded with a computer program. In this regard, memory 620 stores data and instructions that are readable and executable by processor 615 for controlling the operation of processor 615. Memory 620 may be implemented in a random access memory (RAM), a hard drive, a read only memory (ROM), or a combination thereof. One of the components of memory 620 is a program module 625.

Program module 625 contains instructions for controlling processor 615 to execute the methods described herein. Processor 615, under control of program module 625 may provide commands to other devices in communication therewith. For example, processor 615 may be in communication with a camera, a laser device, a rotational mirror, a counter, memory 620, or combinations thereof. Processor 615 may command the laser device to produce laser light. Processor 615 may also command a rotational mirror to rotate about an axis. In this fashion, laser light produced by the laser device may be reflected from the rotational mirror to produce laser light throughout a plane. Further, processor 615 may also command the camera to record an image when a flash is produced. Processor 615 may also command the counter to count the total number of flashes. A flash occurs when an object obstructs and reflects the laser light thereby creating a difference in light gradient resulting in a flash. Processor 615, in communication with database 620, may transfer the image recorded by the camera, and/or transfer the count total from the counter to database 620 for storage.

The term “module” is used herein to denote a functional operation that may be embodied either as a stand-alone component or as an integrated configuration of a plurality of sub-ordinate components. Thus, program module 625 may be implemented as a single module or as a plurality of modules that operate in cooperation with one another. Moreover, although program module 625 is described herein as being installed in memory 620, and therefore being implemented in software, it could be implemented in any of hardware (e.g., electronic circuitry), firmware, software, or a combination thereof.

Processor 615 outputs, to user interface 610, a result of an execution of the methods described herein. Alternatively, processor 615 could direct the output to a remote device (not shown) via network 630. For example, user interface 610 may display the recorded images and may also display the count total. Alternatively, processor could direct the stored images and/or count total to a different database or remote device via network 630.

While program module 625 is indicated as already loaded into memory 620, it may be configured on a storage medium 635 for subsequent loading into memory 620. Storage medium 635 is also a computer-readable medium encoded with a computer program, and can be any conventional storage medium that stores program module 625 thereon in tangible form. Examples of storage medium 635 include a floppy disk, a compact disk, a magnetic tape, a read only memory, an optical storage media, universal serial bus (USB) flash drive, a digital versatile disc, or a zip drive. Alternatively, storage medium 635 can be a random access memory, or other type of electronic storage, located on a remote storage system and coupled to computer 605 via network 630.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A system comprising:
a. a laser device that produces a laser beam;
b. a mirror that rotates about an axis and reflects said laser beam throughout a plane, said plane being substantially horizontal, said visible field being a portion of said plane, wherein, when an object obstructs said laser beam, a flash is produced;
c. a camera that has a visible field and detects said flash; and
d. a counter that records a count when said flash is produced and detected by said camera.

2. The system of claim 1, wherein said system is underwater submersible.

3. The system of claim 1, further comprising:
a database in communication with said counter, wherein said database stores said count.

4. The system of claim 3, wherein said camera detects said flash and records an image of said visible field.

5. The system of claim 4, further comprising:
an access device in communication with said database, wherein said access device displays said recorded image and said stored count.

6. The access device of claim 4, wherein the access device is a display panel.

7. The system of claim 1, wherein said camera is disposed perpendicularly to said laser beam.

8. The system of claim 1, wherein said laser device is affixed to a bottom portion of said camera.

9. The system of claim 1, wherein said mirror rotates by a motor.

10. The motor of claim 9, wherein said motor is an electromotor.

11. The system of claim 9, wherein said motor and said laser device are powered by an autonomous power supply.

12. The system of claim 9, wherein said motor is powered by a first power supply and said laser device is powered by a second power supply.

13. The system of claim 1, wherein said laser device and said mirror are situated below said camera.

14. The system of claim 13, wherein said laser and said mirror are situated below said camera by a placement device.

15. A system comprising:
a. a laser device that produces a laser beam;
b. a mirror that rotates about an axis and reflects said laser beam throughout a plane, said plane being substantially horizontal;
c. a camera, wherein said camera records an image of a portion of said plane; and
d. a microprocessor in communication with a database and said camera, wherein said microprocessor transfers said recorded image from said camera to said database and said database stores said recorded image.

16. A method comprising:
a. producing a light throughout a plane using a laser beam and a rotational mirror, said plane being substantially horizontal,
b. detecting a flash within a portion of said plane with a camera; wherein, an object obstructs said laser beam and wherein said flash is produced,
c. recording objects as an image with said camera when said flash is produced; said camera being in communication with a database,
d. storing said image in a database.

17. The method of claim 16, being performed underwater.

18. The method of claim 16, further comprising the step of recording a count total with a counter, wherein said counter increases said count total when said flash is produced.

19. The method of claim 16, wherein said objects being recorded a video with said camera, said video being stored in said database.
